(19) United States
(12) Patent Application Publication
(10) Pub. No.: US 2004/0012325 A1
(43) Pub. Date: Jan. 22, 2004

(54) Use of a uva illuminant

(76) Inventors: Gerhard Döll, (US); Reinhard Lecheler, Neuburg/Donau (DE); Ulrich Müller, M?uuml;nchen (DE)

Correspondence Address: OSRAM SYLVANIA INC, 100 ENDICOTT STREET, DANVERS, MA, 01923, US

(21) Appl. No.: 10/380,239

(22) PCT Filed: Jun. 12, 2002
(86) PCT No.: PCT/DE02/02142

(30) Foreign Application Priority Data
Jul. 13, 2001 (DE) 101 33 411.7

(51) Int. Cl. H01J 1/62; C09K 11/08

(52) U.S. Cl. 313/486; 252/301.4 R

(57) ABSTRACT

The invention relates to the use of an aluminate phosphor CeYRMgAlO, in which R. represents Ba, Ca and/or Sr, for excitation with VUV radiation. Moreover, the invention relates to a corresponding discharge lamp and to a correspondingly designed tanning device.

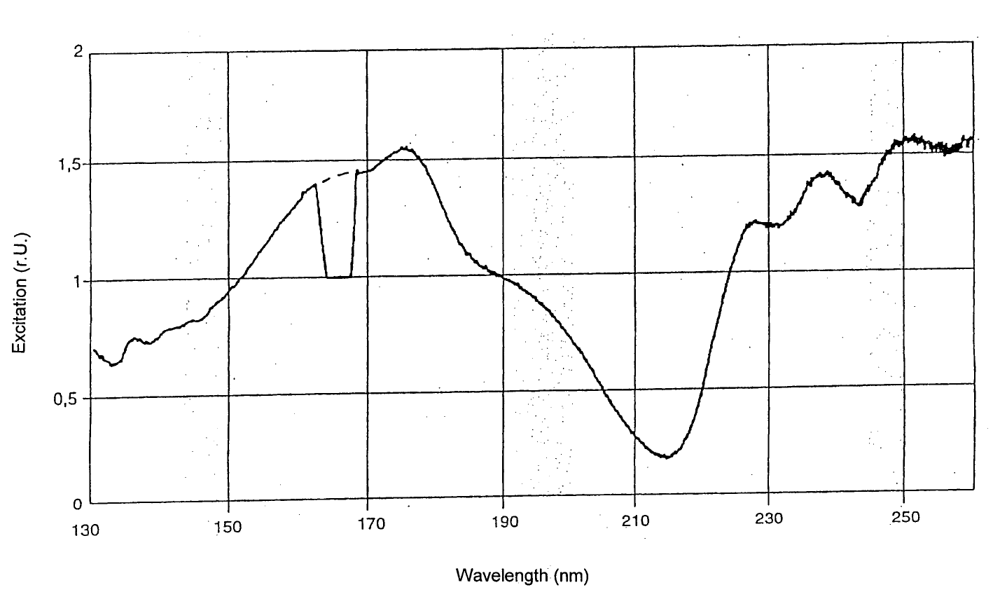

### TECHNICAL FIELD

The invention relates to the generation of UVA radiation using a phosphor as described in the preamble of claim 1.

### PRIOR ART

UVA radiation can be generated by phosphors when they have been excited with relatively short-wave radiation. In this context, it is known to excite aluminate phosphors using conventional UV radiation from a mercury low-pressure discharge, i.e. from an Hg discharge (main excitation wavelength approximately 254 nm). Reference is made to U.S. Pat. No. 4,216,408, U.S. Pat. No. 4,153,572 and U.S. Pat. No. 4,088,922.

### SUMMARY OF THE INVENTION

The invention is based on the technical problem of providing a widened range of options for generating UVA radiation using a phosphor.

The invention relates to the use of an aluminate phosphor of the empirical formula

Ce_{a-c}Y_{b}R_{c}Mg_{d}Al₁₁O_{16.5+1.5(a+b)-0.5c+d}

where R represents Ba, Ca and/or Sr

and the following statements apply to a, b, c, d:

0.14≦a≦1.00

0≦b≦0.35

0≦c≦0.5a

0.45≦d≦2

a+b≦1

for excitation with short-wave UV radiation with a wavelength of below 200 nm, known as VUV radiation.

In addition, the invention also relates to a discharge lamp using the phosphor described which is designed for VUV excitation of the phosphor, to a tanning device having a discharge lamp of this type and to the use of a discharge lamp of this type for photocatalytic purification.

It is assumed that the above described aluminate phosphor is a known material. However, it was not hitherto known that this phosphor can be excited to good effect in the VUV region. Rather, it has been assumed that the extent to which the phosphor can be excited decreases toward short UV wavelengths.

Surprisingly, it has now emerged that the extent to which this phosphor can be excited at short UV wavelengths, i.e. in what is known as the VUV region, increases again and therefore this phosphor is eminently suitable for generating UVA radiation from VUV radiation.

In accordance with claim 1, the phosphor is characterized in general terms by the empirical formula Ce_{a-c}Y_{b}R_{c}Mg_{d}Al₁₁O_{16.5+1.5(a+b)-0.5c+d}, where R represents Ba, Ca and/or Sr and the following statements apply to a, b, c, d: 0.14≦a≦1.00, 0≦b≦0.35, 0≦c≦0.5a, 0.45≦d≦2, a+b≦1.

However, the invention also relates to various preferred relatively high lower limits and relatively low upper limits for the parameters a, b, c and d, which are presented below:

0.5 a≦1.00; 0≦b≦0.20; 0≦c≦0.2a; 0.50≦d≦1.50

and

0.80≦a≦1.00; 0≦b≦0.05; 0≦c≦0.1a; 0.90≦d≦1.10.

Moreover, the O content may deviate slightly from the indicated parameter 11, for example may be up to approximately 12.

Excitation can preferably be effected using a wavelength in the range between 145 and 185 nm, since in this range the phosphor has a favorable excitability curve.

Radiation of this type can be generated, for example, by an Xe excimer discharge. In previous years, discharges of this type have been generated using dielectric barrier discharges, in connection with which reference is made to the relevant prior art. The dielectric barrier discharges can be generated with a particularly good efficiency using a pulsed operating mode, since typical discharge structures are formed with a relatively low current density and also allow the generation of radiation which is homogeneous both in terms of time and location. In this context, reference is made to U.S. Pat. No. 5,714,835. If, in this way, an Xe excimer discharge is used, for example, of Xe₂*, a molecular band radiation in the region of approximately 172 nm occurs, i.e. within the abovementioned preferred excitation range. This radiation satisfies the range of optimum excitability of the phosphor which forms the subject of the invention relatively well.

A preferred aspect of the invention relates to the fact that the UVA radiation which is generated by the described phosphor is used to excite a further phosphor. This may be of interest if, on the one hand, a certain UVA-excitable phosphor is of interest, and on the other hand, if the advantages of, for example, a pulsed dielectric barrier discharge are to be exploited. This is also of interest if a phosphor is to be excited at a location which cannot be reached directly by the discharge which generates the VUV radiation. This is because VUV radiation is strongly absorbed by air and therefore can only be transmitted through a vacuum. However, this is not true of UVA radiation. If visible light is to be generated in a display, for example, and a specific UVA-excitable phosphor is suitable for this purpose, the phosphor according to the invention is able to generate UVA radiation by means of VUV excitation, and this UVA radiation can be transmitted from the UVA lamp formed in this way, through air or other media if appropriate, to the UVA-excitable phosphor. This may be of interest if the advantages of a dielectric barrier discharge over a conventional Hg discharge, which are already known per se, are of interest. These advantages consist, inter alia, in the fact that the luminance of the discharge is scarcely temperature-dependent, and there is therefore scarcely no start-up characteristic, and moreover the discharge lamps have an extraordinarily high switching endurance and service life.

The UVA region which is under consideration lies at wavelengths from approximately 300-380 nm.

As has already been established in the introduction, the invention relates not only to the use of the aluminate phosphor described under excitation with short-wave UV radiation (wavelength <200 nm), but also to discharge lamps in which a VUV excitation may take place and which are provided with the aluminate phosphor which has been described above.

Discharge lamps of this type may have various preferred uses. For example, they may be designed as a signaling device or, in the manner described above, as an excitation source for a display which is operated with UVA-excitable phosphors. However, they may also be designed as UVA radiators, for example for a tanning device, which is likewise to be protected. This is because UVA radiation is required in sunlamps, solaria and similar tanning devices, while on the other hand the flat structure which can be achieved with dielectric barrier discharge lamps is recommended. Moreover, in these cases accurate monitoring of the radiated dose is necessary, and consequently the start-up characteristic of conventional discharges causes problems. Moreover, a long service life and very good maintenance are of interest in this application area. Moreover, for reasons of environmental protection it is desirable for the element Hg as far as possible not to be used in products.

A further inventive aspect relates to the use of the abovementioned UVA radiator for photocatalytic purification. This is because it has been found that this UVA radiator is particularly suitable for this purpose, in particular if the catalyst used is titanium oxide. When irradiated using the UVA radiator, a catalyst of this type is particularly suitable for breaking up carbon compounds, in particular soot.

### DESCRIPTION OF THE DRAWING

In the text which follows, the invention is explained in more detail with reference to an exemplary embodiment, the FIGURE showing a measurement curve illustrating the excitability of the phosphor according to the invention in the VUV region (wavelength <200 nm) and the UV region (wavelength 200-260 nm).

The FIGURE shows the relative excitability of the phosphor according to the invention having the following precise composition: Ce_{0.90} Ba_{0.05}MgAl₁₁O₁₈, ₉₀, i.e. a=0.95, b=0, c=0.05, d=1.

The curve is standardized in the customary way to the values for Na salicylate. The irregular dip in the curve at approximately 165 nm is a result of the measurement technology used and results from overloading caused by the resonant peak of the exciting deuterium lamp.

It is clearly apparent that the excitability drops considerably between 230 nm and 220 nm, as was already known per se. However, between 200 nm and 180 nm it rises again to values which are practically identical to those achieved in the region around 250 nm. Therefore, the excitability is very high precisely in the wavelength region which is of interest for the Xe₂* discharge. By contrast, the drop toward lower wavelengths below 150 nm is of no importance.

The following table presents what is known as the maintenance of this phosphor in dielectric barrier Xe₂* discharge lamps. Φ represents the radiation flux, specifically for the new lamps, after 100 operating hours, 500 operating hours and 1000 operating hours, with the direct measured values, on the one hand, being presented using relative units and the values which have been standardized to the starting value over the course of time, on the other hand, being presented in percentage form. The values determined for maintenance and scatter are considered to be favorable.

Maintenance of the UVA phosphor according to the invention under Xe₂*
discharge

| | | | | Φ | | | Φ |
|---|---|---|---|---|---|---|---|
| Lamp | Φ 0 h | Φ 100 h | Φ 500 h | 1000 h | Φ 100 h | Φ 500 h | 1000 h |
| No. | [r.U.] | [r.U.] | [r.U.] | [r.U.] | [%] | [%] | [%] |
| CE559 | 70.0 | 68.7 | 65.5 | 62.5 | 98 | 94 | 89 |
| CE560 | 77.0 | 76.5 | 76.7 | 72.7 | 99 | 100 | 94 |
| CE561 | 77.0 | 75.0 | 77.0 | 74.0 | 97 | 100 | 96 |
| CE562 | 76.0 | 76.5 | 75.0 | 71.8 | 101 | 99 | 94 |
| | | | | Mean: | 99 | 98 | 93 |
| | | | | Std dev: | 1.7 | 2.9 | 3.0 |
| | | | | ΔΦ: | 1 | 2 | 7 |

1. The use of an aluminate phosphor of the empirical formula
Ce_{a-c}Y_{b}R_{c}Mg_{d}Al₁₁O_{16.5+1.5(a+b)-0.5c+d}
where R represents Ba, Ca and/or Sr
and the following statements apply to a, b, c, d:
0.14≦a≦1.00
0≦b≦0.35
0≦c≦0.5a
0.45≦d≦2
a+b≦1
for excitation of the phosphor with VUV radiation.

2. The use as claimed in claim 1, in which the excitation range lies between 145 and 185 nm.

3. The use as claimed in claim 2, in which the exciting radiation is generated by an Xe excimer discharge.

4. The use as claimed in claim 1, 2 or 3, in which the exciting radiation is generated by a gas discharge operated in pulse mode.

5. The use as claimed in claim 1, 2 or 3, in which the UVA radiation which is generated by the phosphor is used to excite a further phosphor.

6. The use as claimed in claim 5, in which the further phosphor generates visible light.

7. A discharge lamp, in which the phosphor described in claim 1 is used as claimed in one of claims 1 to 6.

8. The discharge lamp as claimed in claim 7, which is designed as a signaling device.

9. The discharge lamp as claimed in claim 7, but not in conjunction with claim 6, which is designed as a UVA radiator.

10. The use of the discharge lamp as claimed in claim 9 for a tanning device.

11. A tanning device having the discharge lamp as claimed in claim 9.

12. The use of the discharge lamp as claimed in claim 9 for photocatalytic purification.

13. The use as claimed in claim 12 in combination with a titanium oxide catalyst.
